(19) United States
(12) Patent Application Publication
(10) Pub. No.: US 2014/0369914 A1
(43) Pub. Date: Dec. 18, 2014

(54) ACIDIC GAS COLLECTION SYSTEM

(71) Applicant: KABUSHIKI KAISHA TOSHIBA, Tokyo (JP)

(72) Inventors: Naomi TSUCHIYA, Yokohama (JP); Takashi OGAWA, Yokohama (JP); Masatoshi HODOTSUKA, Saitama (JP)

(73) Assignee: KABUSHIKI KAISHA TOSHIBA, Tokyo (JP)

(21) Appl. No.: 14/293,202

(22) Filed: Jun. 2, 2014

(30) Foreign Application Priority Data
Jun. 14, 2013 (JP) 2013-125998

(51) Int. Cl. B01D 53/62; B01D 53/96; B01D 53/56

(52) U.S. Cl. CPC B01D 53/62; B01D 53/56; B01D 53/96
USPC 423/228; 423/210; 422/169

(57) ABSTRACT

A gas collection method comprises contacting a gas mixture including a weak acidic gas and a strong acidic gas with amine solution that absorbs a first portion of the gas mixture. After this first contacting step the gas mixture is contacted with amine solution that absorbs a second portion of the mixture. The amine solution after the second contacting step is heated to discharge at least some portion of the weak acid gas component absorbed therein. The method also includes adding an alkaline compound to the amine solution to generate a salt by reaction with the strong acidic component. The salt is separated from the amine solution and this amine solution can be used in the second contacting step.

### CROSS-REFERENCE TO RELATED APPLICATION

This application is based upon and claims the benefit of priority from Japanese Patent Application No. 2013-125998, filed Jun. 14, 2013, the entire contents of which are incorporated herein by reference.

### FIELD

Embodiments described herein relate generally to methods and systems for collection of an acidic gas from combustion exhaust gas.

### BACKGROUND

Development of a technique for reducing the discharge of greenhouse gases is of global concern. In particular, the suppression of carbon dioxide discharge by the burning of fossil fuels has been pursued as a means for reducing greenhouse gas emissions. Though there are various power generation systems which do not rely on the combustion of fossil fuels, as of yet none have been able to supplant fossil fuel-based power generation and fossil fuel-based power generation appears likely to be required for the indefinite future. Therefore, it is preferable to operate fossil fuel-based power generation equipment with systems which function to substantially reduce the discharge of carbon dioxide, such as by way of carbon dioxide recovery/collection systems, to limit emission of greenhouse gases into the atmosphere.

When a collection/recovery technique is applied to a thermal power plant, a method in which carbon dioxide is separated and collected from the hydrocarbon (e.g., fossil fuel) combustion exhaust gas is desirable.

When collecting carbon dioxide from a combustion exhaust gas, an amine method relying on alkanolamines such as monoethanolamine, diethanolamine, triethanolamine, and methyldiethanolamine is generally used. In this amine method, the combustion exhaust gas is brought into contact with an amine solution which absorbs acidic components in the exhaust gas. The acidic component in this context is mainly carbon dioxide, through other acidic compounds may be present in the exhaust gas. The carbon dioxide absorbed into the amine solution is subsequently discharged from the amine solution, for example, by heating the amine solution. Once the carbon dioxide has been discharged from the amine solution, the amine solution may be recirculated within the collection system to again collect carbon dioxide from the exhaust gas stream supplied to the collection system.

In general, the combustion exhaust gas includes a variety of components along with carbon dioxide, such as acidic gases other than the carbon dioxide, neutral gases (such as nitrogen (N₂)or oxygen (O₂)), and solid (particulate) content such as dust. The acidic gases other than the carbon dioxide (which itself is only weakly acidic) such as nitrogen oxides, sulfur oxides, or hydrogen chloride, for example, are generally more strongly acidic than carbon dioxide.

The presence of these strong acidic gases is potentially problematic with respect to regeneration and recirculation of the amine solution in the carbon dioxide collection system. When carbon dioxide is absorbed in the amine solution, strong acidic gases, such as sulfur oxides and nitrogen oxides, that are included in minor or even trace amounts in the exhaust gas are absorbed into the amine solution along with the carbon dioxide, and are ionized in the solution. Ions derived from the strong acidic gases are bonded with the amine in the solution to form heat stable amine salts (“HSAS”).

An amine solution including HSAS in a large amount has a relatively low uptake capability for carbon dioxide, and more energy may be required to collect the carbon dioxide from the amine solution. In addition, since the sulfur oxides or the nitrogen oxides tend to degrade the amine compound included in the amine solution, the sulfur oxides or the nitrogen oxides are preferably removed by desulphurization or denitrification equipment before bringing the combustion exhaust gas into contact with the amine solution.

In particular, since the sulfur oxides, which are strongly acidic components, are more readily absorbed into the amine solution than carbon dioxide, desulphurization equipment is often provided to “pre-treat” the combustion exhaust gas before input into the carbon dioxide collection system.

In addition, in conventional carbon dioxide collection systems, the amine solution, which absorbs the acidic gases, is recirculated through the collection system sequentially through an absorber unit and a regenerator unit then returned to the absorber unit. In particular, within the regenerator unit the amine solution is heated to discharge the carbon dioxide absorbed in the absorber unit. But this heating also serves to promote the degradation of the amines in the amine solution. Therefore, since carbon dioxide absorption and discharge performance the amine solution is decreased over time with regular use in the system and also degraded by the presence of even trace amounts of sulfur oxides and nitrogen oxides, typically the amine solution must be regularly replaced even when the exhaust gas is first treated (pre-treated) by desulphurization and/or denitrification equipment.

However, in general, since the volume of amine solution which must be replaced is large with thermal power plants, waste amine solution, must still be treated before being output to the environment. As such, waste amine solution which is to be discarded must generally be first passed through a neutralization treatment and a detoxification treatment. Therefore, the overall cost for replacing the “spent” amine solution becomes very high. Therefore, it is generally desired to use the amine solution for as long as possible in the carbon dioxide collection system to avoid or mitigate these replacement/disposal expenses.

In addition, since an amine component is still present in the waste amine solution, it is not particularly desirable that the entire waste amine solution is discarded, but rather it may be preferable to discard only the degraded or inactive portions of the waste amine solution and to recycle or re-use the still potentially effective portions of the solution, if possible.

A vacuum distillation technique has been proposed as a method for selectively collecting still effective portions of the amine solution from the waste amine solution. However, this technique generally requires equipment with an installation area (installed footprint) that is large. Additionally, a heat source (thermal energy) is necessary to perform distillation of the waste amine solution. Therefore, the overall required energy and cost for a carbon dioxide recovery system including such vacuum distillation equipment separating and collecting the carbon dioxide from becomes high and may not be appropriate when considering the overall efficiency of the thermal power plant.

### DESCRIPTION OF THE DRAWINGS

FIG. 1 is a diagram illustrating an acidic gas collection system according to a first embodiment.

FIG. 2 is a diagram illustrating an amine solution regenerative apparatus according to the first embodiment.

FIG. 3 is a diagram illustrating an amine solution regenerative apparatus according to a second embodiment.

FIG. 4 is a diagram illustrating an acidic gas collection apparatus according to the second embodiment.

### DETAILED DESCRIPTION

Embodiments described herein relate generally to a method of carbon dioxide recovery from combustion exhaust gases including a mixture of acidic gases. Example embodiments concern the collection of carbon dioxide (a weakly acidic gas) from a fossil fuel combustion exhaust gas such as that resulting from the burning of coal in a power plant. In particular, the example embodiments describe carbon dioxide collection systems and methods using an amine-based solution as recirculating component used to initially absorb carbon dioxide from the combustion exhaust then later discharge the carbon dioxide for collection/sequestration. Additionally, the example embodiments described herein relates to an acidic gas collection system using a method/apparatus for regenerating an amine solution previously degraded by absorption of acidic gas components, particularly strong acidic components. The exemplary embodiments provide methods and apparatuses for using and regenerating an amine solution used in an acidic gas collection system, which thereby reduces the amount of a waste amine solution to be discarded from an acidic gas collection system and therefore reduces expenses related to amine solution replacement and disposal.

In general, according to an embodiment, a gas collection method includes: contacting an acidic gas mixture including a weak acidic gas component (e.g., carbon dioxide) and a strong acidic gas component (e.g., nitrogen oxides), with a first amine solution which absorbs a first portion of the acidic gas mixture to provide a second amine solution including the first portion of the acidic gas mixture absorbed therein. The first portion may include primarily portions of the strong acidic gas component, for example. After the initial contacting operation, the acidic gas mixture, that was previously contacted by the first amine solution, is contacted with a third amine solution which absorbs a second portion of the acidic gas mixture to provide a fourth amine solution including the second portion of the acidic gas mixture absorbed therein. The second portion may include primarily portions of the weak acidic gas component. The fourth amine solution is then heated to discharge at least some portion of the weak acid gas component from the fourth amine solution to provide a fifth amine solution with less weak acid gas component than the fourth amine solution. An alkaline compound is added to the second amine solution to generate a salt from the reaction of the alkaline compound and the strong acidic component absorbed therein. The reaction salt can then be separated from the second amine solution to thereby generate a sixth amine solution from which at least a portion of the salt has been removed. The fifth amine solution and the sixth amine solution car then combined to provide the third amine solution used for absorbing the second portion of the acidic gas mixture.

In general, according to an embodiment, an acidic gas collection method is provided. In this method, by bringing an untreated acidic gas mixture, in which at least one kind of a weak acidic gas and at least one or more kinds of strong acidic gases are included, into contact with an amine solution, the weak acidic gas and the strong acidic gas are absorbed into the amine solution, and the weak acidic gas is collected from the amine solution after the absorption. The acidic gas collection method includes (1) allowing the strong acidic gas to be absorbed into the amine solution by bringing the untreated acidic gas mixture into contact with the amine solution, (2) allowing the weak acidic gas to be absorbed into the amine solution by bringing an acidic gas mixture after (1) into contact with the amine solution, and (3) heating the amine solution after it has been used in (2), collecting the weak acidic gas by discharging the weak acidic gas absorbed in the amine solution, and recovering a weak acidic gas absorption capability of the amine solution, wherein at least a part of the amine solution treated by (3) is used in (2), after performing a solid-liquid separation after the strong acidic gas and an alkaline compound have been allowed to react by adding the alkaline compound to at least a part of the amine solution after (2) or (3), an acidic gas absorption capability is recovered, and the amine solution, after the acidic gas absorption capability recovery, is used in (1).

According to an embodiment, an acidic gas collection apparatus is provided for treating an acidic gas mixture in which at least one weak acidic gas and at least one strong acidic gas are included. The apparatus includes: (1) a strong acidic gas removing tower in which a strong acidic gas is absorbed into an amine solution by bringing the acidic gas mixture into contact with the amine solution, (2) an absorption tower in which weak acidic gas is absorbed by bringing the acidic gas mixture after treatment in the strong acidic gas removing tower into contact with an amine solution, and (3) a regeneration tower in which the amine solution from the absorption tower is heated causing the weak acidic gas to be discharged from the amine solution. The weak acidic gas maybe collected after being discharged from the amine solution. The apparatus also includes (a) a pipe for supplying the amine solution from the strong acidic gas removing tower to the absorption tower (b) a pipe for supplying the amine solution from the absorption tower to the regeneration tower, and (c) a pipe for supplying the amine solution from the regeneration tower to the absorption tower, and (4) an amine solution regenerative apparatus in which the strong acidic gas absorption capability is recovered by performing solid-liquid separation after the strong acidic gas and the alkaline compound are allowed to react by adding the alkaline compound to the amine solution, and (d) a pipe which is branched from the pipe (b) or (c), for supplying at least a part of the amine solution to the amine solution regenerative apparatus (4).

Hereinafter, exemplary embodiments will be described with reference to the drawings.

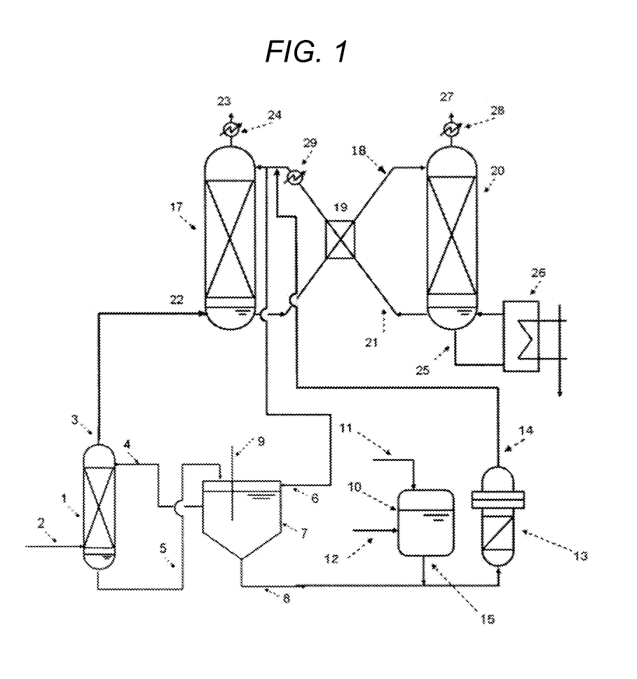

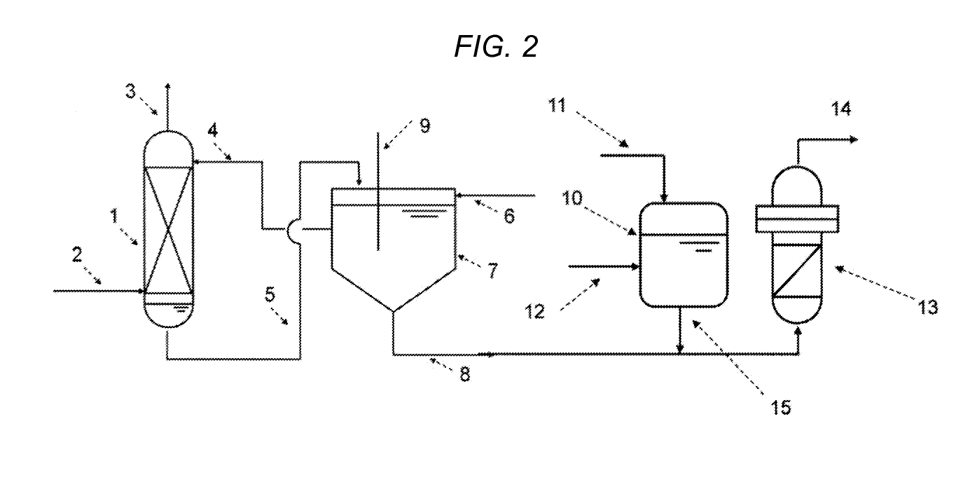

FIG. 1 is a diagram illustrating an acidic gas collection apparatus according to a first embodiment. FIG. 2 depicts an amine solution regenerative unit which can be incorporated in the acidic gas collection apparatus of the first embodiment. An acidic gas collection method of an embodiment may be achieved by the acidic gas collection apparatus illustrated in FIG. 1, for example.

A gas to be treated may include a plurality of gases with different acidities—that is, the gas may comprise an acidic gas mixture including at least one strongly acidic gas (a strong acidic gas component) and at least one weakly acidic gas (a weak acidic gas component). One example of the gas to be treated contains carbon dioxide produced by combustion of fossil fuels, such as coal. Such a combustion exhaust gas typically comprises an acidic gas mixture, which generally includes minor amounts of nitrogen oxides or sulfur oxides, which are both strong acidic gases. The carbon dioxide in such a gas is a weakly acidic gas (weak acidic gas).

Before such an exhaust gas is scrubbed of acidic gases, the exhaust gas is generally first cooled in a cooling tower (not specifically illustrated in the figure), and then additional processes such as denitrification, dust removal, desulfurization and the like are performed. However, the denitrification, the desulfurization, and the dust removal processes do not generally fully achieve their intended objectives. That is, some amount, perhaps merely trace amounts, of nitrogen oxides, sulfur oxides, and dust will still remain in the exhaust gas after these initial treatment processes. Additionally, other minor exhaust components (e.g., chlorine) not directly addressed by a pretreatment process may still be present in the exhaust gas.

After the exhaust gas is treated/cooled in the cooling tower, it is introduced via a gas introduction line 2 into the acidic gas collection apparatus depicted in FIG. 1 so that the acidic gas, such as carbon dioxide, in the exhaust gas can be collected.

An acidic gas collection method comprises:

(1) absorbing a strong acidic gas component from the exhaust gas by bringing the untreated exhaust gas mixture into contact with “spent” amine solution,

(2) absorbing a weak acidic gas component from the exhaust gas by bringing exhaust gas after process (1) (that is the exhaust gas previously exposed to “spent” amine solution) into contact with “fresh” and/or “regenerated” amine solution, and

(3) heating the amine solution used in process (2) to discharge the weak acidic gas absorbed therein.

The process (1) may be performed in a strong acidic gas removing apparatus 1, the process (2) may be performed in an absorption tower 17, and the process (3) may be performed in a regeneration tower 20.

First, the acidic gas mixture (in the combustion exhaust gas) is introduced via the gas introduction line 2 into the strong acidic gas removing tower 1. In tower 1, the acidic gas mixture comes into contact with an amine solution. This amine solution has been previously used in the weak acidic gas absorption process in absorption tower 17 and in this context may be referred to as “spent” amine solution, though this amine solution may still be capable of absorbing weak acidic gases and may indeed be chemically indistinguishable from what may be referred to as “regenerated” amine solution output from absorption tower 17. The weak acidic gas absorption capability of this “spent” amine solution is reduced compared to amine solution (fresh amine solution) which has not been previously used in absorption tower 17, however, the strong acidic gas absorption capability of this previously used amine solution is sufficient for the purpose of use in the strong acidic gas removing tower 1, as the “spent” amine solution will still absorb the strong acidic gas. Therefore, the strong acid component which remains after the cooling tower processing and other pre-treatments, for example, traces of nitrogen oxides or sulfur oxides, are absorbed in this “spent” amine solution. Such a strong acidic gas removing tower 1 may sometimes be referred to as a desulfurization tower.

The acidic gas mixture treated in the strong acidic gas removing tower 1 is then supplied to the absorption tower 17 through a pipe 22. As used in this context, “pipe” encompasses connections for transmitting a fluid between components and includes pipes, ducts, channels, tubes, conduits, hoses, lines, and the like without limitation.

In the absorption tower 17, the acidic gas mixture comes into contact with amine solution; however, since this amine solution is “fresh,” or has been regenerated in the regeneration tower 20, the weak acidic gas absorption capability of this amine solution is high. Therefore, it is possible to absorb the weak acidic gas from the acidic gas mixture previously treated in strong acidic gas removing tower 1. Moreover, the temperature of the amine solution in the absorption tower 17 can be adjusted in accordance with composition or components, and the temperature of the amine solution in the absorption tower 17 is generally about 30° C. to 70° C.

The exhaust gas after treatment in tower 17 is discharged via a treated gas discharge line 23 to the outside of the system through a treated gas cooler 24.

The amine solution abundantly includes the weak acidic gas after absorbing the weak acidic gas in the absorption tower 17. As a result, the weak acidic gas absorption capability of this amine solution is decreased. This amine solution is supplied to the regeneration tower 20 through a pipe 18.

In the regeneration tower 20, the supplied amine solution is regenerated by separating the weak acidic gas from the amine solution.

In the example illustrated in FIG. 1, after being supplied to a reboiler 26 through a pipe 25 and heated in reboiler 26, the supplied amine solution is returned to the regeneration tower 20. As a result, the weak acidic gas is separated and discharged from the amine solution in the regeneration tower 20. The separated weak acidic gas is discharged via an acidic gas-containing gas discharge line 27 to the outside of the system through an acidic gas cooler 28 and then collected. That is, here the weak acidic gas is collected from the acidic gas mixture (exhaust gas) initially input to the strong acidic gas removing tower 1. The amine solution from which the weak acidic gas was separated is returned to the absorption tower 17, and this regenerated amine solution is again used for absorbing the weak acidic gas in the absorption tower 17. The operation temperature in the regeneration tower can be adjusted in accordance with a composition or components of the amine solution, and/or the content of carbon dioxide in the amine solution, and this operating temperature is generally 80° C. to 300° C.

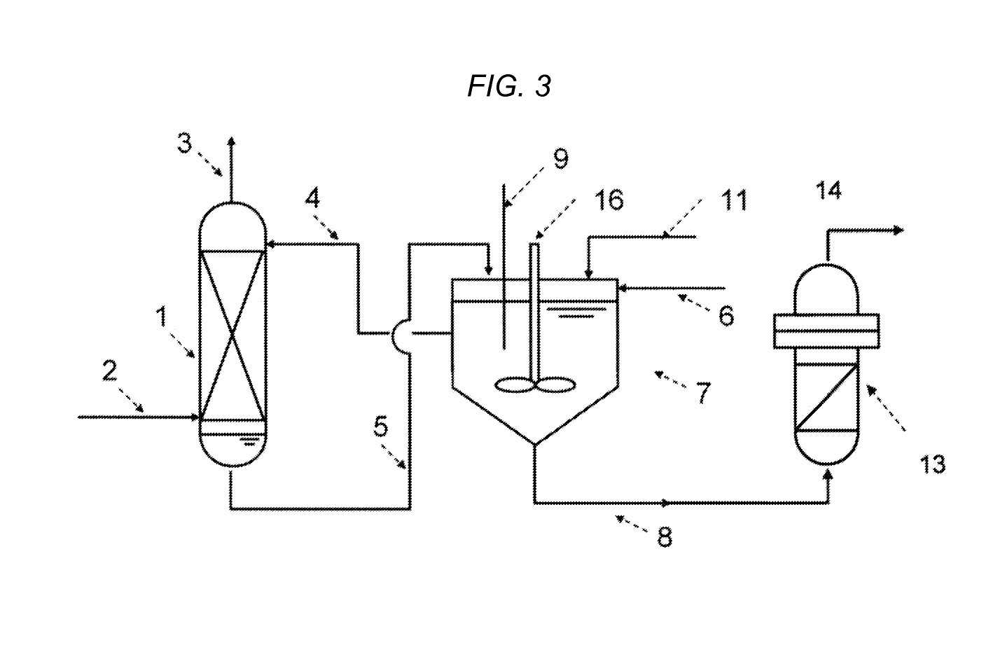

In the acidic gas collection system illustrated in FIG. 1, at least a part of the amine solution output from the regeneration tower 20 is used for the absorption of the strong acidic gas in the strong acidic gas removing apparatus 1. That is, a first portion of the regenerated amine solution is supplied to tower 17 and a second portion is supplied (indirectly as discussed below) to tower 1. The second portion of the regenerated amine solution is supplied from the regeneration tower 20 to the amine solution regenerative apparatus (see e.g., FIG. 2 and FIG. 3) through a pipe 6. Specifically, this portion of the amine solution is supplied to an amine solution storage tank 7 and stored therein. A pH meter (element 9) is arranged in the amine solution storage tank 7, and the pH state of the amine solution in the storage tank 7 is monitored.

The amine solution in the amine solution storage tank 7 has been previously used for absorption of the weak acidic gas in the absorption tower 17 at least once, and the weak acidic gas absorption capability of this amine solution is therefore decreased compared to the fresh amine solution; however, this used amine solution still has sufficient strong acidic gas absorption capability. In this context, the amine solution in amine solution storage tank 7 is referred to as “spent” amine solution.

Specifically, the weak acidic gas (e.g., carbon dioxide) will not be significantly absorbed in the amine solution when the amine solution is close to neutral but still mildly basic (about pH 8 to 9). However, even if the amine solution is mildly acidic, the strong acidic gas may still be absorbed.

The amine solution is supplied from storage tank 7 to the strong acidic gas removal tower 1 through a line 4. In tower 1, this amine solution from storage tank 7 is brought into contact with the acidic gas mixture, and absorbs strong acidic gas from the acidic gas mixture. The amine solution after absorbing the strong acidic gas is re-circulated to the amine solution storage tank 7 through a line 5, and the pH state of the stored amine solution is monitored by the pH meter 9.

Once it is determined by pH monitoring that the ability of the stored amine solution to absorb the strong acidic gas has been substantially reduced, an alkaline compound is introduced to the stored amine solution to react with at least a part of the strong acidic component in the amine solution, the reaction product of the strong acidic component and the added alkaline compound can be separated from the amine solution, by this, the strong acidic component is removed from the amine solution, and thus the acidic gas absorption capability of the amine solution is substantially recovered.

For this amine solution recovery process, when pH of the stored amine solution indicates the stored amine solution has a significantly reduced strong acidic gas absorption capability, an alkaline aqueous solution is introduced from an alkaline aqueous solution transfer line 15 into the amine solution. The solid reaction product is discharged (along with amine solution) from the amine solution storage tank 7 through a pipe 8. The solid component is removed from the amine solution by a solid-liquid separation system 13. After separation of the solid reaction product, the resultant amine solution from solid-liquid separation system 13 is supplied to the absorption tower 17, through a line 14.

Any system for separating solids from liquids maybe used as the solid-liquid separation system 13.

When a solid is mixed in the amine solution, the solid may become a cause of a line clogging or may also cause an eventual increase in the separation and collection energy costs of the entire system by causing scale formation on inner walls of system pipes and equipment. Therefore, a solid-liquid separation system 13 including a filtration apparatus may preferably be provided to remove the solid reaction product from the circulating amine solution.

The alkaline aqueous solution transfer line 15 is connected to a solid-liquid mixing tank 10, an alkaline compound input line 11 and a pure water input line 12 are connected to the solid-liquid mixing tank 10, and an alkaline aqueous solution is prepared in the solid-liquid mixing tank. Here, an alkaline compound, such as, for example, sodium hydroxide, magnesium hydroxide, calcium hydroxide, or barium hydroxide may be used, and the alkaline compound may be selected based on which salt (acid-base reaction product) is likely to precipitate from the amine solution including a strong acidic component. In other words, the alkaline compound may be selected such that the expected salt formed by reaction with the strong acidic component(s) has a low solubility in the amine solution. Alkaline compounds such as calcium hydroxide or barium hydroxide may be preferable for this reason in typical carbon dioxide recovery systems. HSAS formed of ions derived from amine which was formed in the amine solution and the strong acidic gas are dissociated by reacting with the alkaline compound, as a result, accumulated HSAS in the amine solution are removed, and the weak acidic gas absorption capability is thus recovered.

In this manner, it is possible to efficiently remove the HSAS by reacting the strong acidic component to generate a solid reaction product, then performing a solid-liquid separation to remove the strong acid components in the amine solution. Using this technique it is possible to reduce the amount of the amine solution that must be discarded as waste by returning the recovered solution, which includes a large amount of the amine components, to the system, specifically, in this embodiment, the absorption tower 17. As a result, the cost for collecting the acidic gas also may be reduced by reducing the requirements for additional, fresh amine solution and also by reducing disposal costs for the “spent” amine solution.

When intending to precipitate a salt from a solution, low temperature is generally advantageous. Therefore, in order to efficiently remove reaction products of the alkaline compounds from the amine solution, it is desirable to cool the amine solution to around 20° C. to 30° C. Since the amine solution is typically cooled for purposes of the solid-liquid separation, the recovered amine solution (amine solution after solid-liquid separation), can be supplied to the upstream of the absorption tower 17, which preferably operates at low temperatures. Thus, it is possible to collect the weak acidic gas in the absorption tower 17 without increasing required the separation and collection energy of the system.

Moreover, although an example in which the alkaline compound aqueous solution is introduced into the amine solution was described, it is possible to introduce a solid alkaline compound rather than an alkaline solution. That is, it is also possible to use the apparatus illustrated in FIG. 3 instead of the amine solution regenerative apparatus illustrated in FIG. 2. The apparatus illustrated in FIG. 3 is not provided with the solid-liquid mixing tank 10, but is provided with a stirring blade 16 and the alkaline compound input line 11 in the amine solution storage tank 7. Then, in the amine solution storage tank 7, the strong acidic gas component absorbed in the amine solution is reacted with an alkali salt, and the reaction mixture is supplied to the solid-liquid separation system 13.

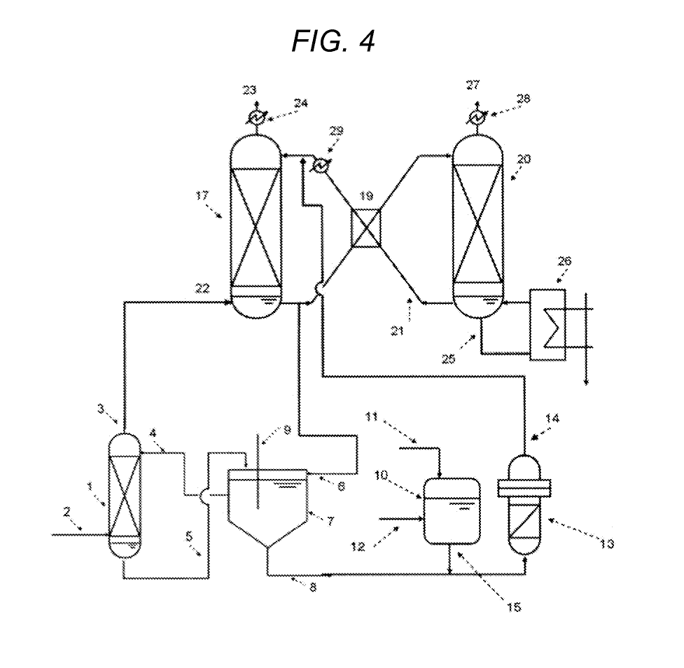

In the system illustrated in FIG. 1, a part (a second portion) of the amine solution supplied from a regeneration tower 20 is supplied (indirectly via the amine solution regenerative apparatus) to the strong acidic gas removing apparatus 1. But as illustrated in FIG. 4, it is also possible to supply the amine solution output from absorption tower 17 to the strong acidic gas removing apparatus 1 (indirectly via the amine solution regenerative apparatus). That is, in the system depicted in FIG. 1, regenerated amine solution output from regeneration tower 20 is supplied to storage tank 7 and in the system depicted in FIG. 4, amine solution output from absorption tower 17 is supplied to the storage tank 7. In other words, pipe 6 may connect between line 21 and storage tank 7 (as in FIG. 1) or pipe 6 may connect between line 18 and storage tank 7 (as in FIG. 4).

In the embodiment depicted in FIG. 4, the amine solution supplied to the strong acidic gas removing tower includes a large amount of the weak acidic gas. For this reason, the strong acidic gas absorption capability is relatively low compared to the system illustrated in FIG. 1. However, in general, carbon dioxide included in the amine solution supplied to the strong acidic gas removing tower 1 is expelled (displaced) from the amine solution by the strong acidic gas (the reaction between the amine and the strong acid component being thermodynamically favored over the reaction between the amine and the weak acid component), and it is therefore still possible to absorb the strong acidic gas. Therefore, it is possible to absorb the strong acidic gas without reducing substantially the content of the weak acidic gas in the gas to be treated, and to introduce a treated gas into the absorption tower.

In addition, a part of the amine solution which circulates between the absorption tower and the regeneration tower is supplied to the amine solution regenerative apparatus illustrated in FIG. 2 or 3, used for absorption of the weak acidic gas again after regeneration, but it is also possible to introduce an amine component concentrator or degraded amine removing apparatus at the upstream or the downstream of the amine solution regenerative apparatus. In such a case, it is desirably attached to the downstream of the regenerative apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A gas collection method, comprising:
contacting an acidic gas mixture including a weak acidic gas component and a strong acidic gas component with a first amine solution which absorbs at least a portion of the strong acidic gas component to provide a second amine solution including the portion of the strong acidic gas absorbed therein;
contacting the acidic gas mixture, that was previously contacted by the first amine solution, with a third amine solution which absorbs at least a portion of the weak acidic gas component to provide a fourth amine solution including the portion of the weak acidic gas absorbed therein;
heating the fourth amine solution to discharge at least some portion of the weak acid gas component from the fourth amine solution to provide a fifth amine solution having less weak acid gas component absorbed therein than the fourth amine solution;
adding an alkaline compound to the second amine solution to generate a salt from the reaction of the alkaline compound and the strong acidic component;
separating the salt from the second amine solution to generate a sixth amine solution from which at least a portion of the salt has been removed; and
combining the fifth amine solution and the sixth amine solution to provide the third amine solution.

2. The method according to claim 1, wherein the alkaline compound comprises at least one of calcium hydroxide and barium hydroxide.

3. The method according to claim 1, wherein the salt precipitates from the second amine solution as a solid.

4. The method according to claim 3, wherein a filtration apparatus is used for separating the salt from the second amine solution.

5. The method according to claim 1, wherein the weak acidic gas component is carbon dioxide formed by combustion of a fossil fuel.

6. The method according to claim 1, further comprising:
measuring a pH level of the second amine solution, wherein adding the alkaline compound to the second amine solution to generate the salt from the reaction of the alkaline compound and the strong acidic component is performed when the pH level of the second amine solution is below a predetermined value.

7. A gas collection method, comprising:
contacting an acidic gas mixture including a weak acidic gas and a strong acidic gas with an amine solution, at least a portion of the strong acidic gas being absorbed into the amine solution and removed from the acidic gas mixture;
adding an alkaline compound to the amine solution to react with the strong acidic gas absorbed therein to form a solid reaction product;
separating the solid reaction product from the amine solution;
contacting the amine solution from which the solid reaction product has been separated with the acidic gas mixture from which at least the portion of the strong acidic gas has been removed, and removing at least a portion of the weak acidic gas from the acidic gas mixture by absorbing the portion of the weak acid gas in the amine solution; and
heating the amine solution in which at least the portion of the weak acidic gas has been absorbed to discharge at least the portion of the weak acidic gas absorbed therein.

8. The method of claim 7, wherein the solid reaction product is separated from the amine solution by filtration.

9. The method of claim 7, wherein the weak acidic gas is carbon dioxide.

10. The method of claim 7, further comprising:
measuring a pH level of the amine solution, wherein the adding of the alkaline compound is performed only when the pH level is below a predetermined level.

11. A gas collection apparatus, comprising:
a first unit configured to receive a first gas stream comprising a gas mixture including a strong acidic component and a weak acidic component and to contact the gas mixture with an amine solution, which absorbs at least a portion of the strong acidic component, and to output a second gas stream including the gas mixture not absorbed by the amine solution and a first solution output stream including the amine solution and at least the portion of the strong acidic component absorbed therein;
a second unit configured to receive the second gas stream from the first unit and to contact the gas mixture therein with the amine solution, which absorbs at least a portion of the weak acidic component, and to output a third gas stream including the gas mixture not absorbed by the amine solution and a second solution output stream including the amine solution and at least the portion of the weak acidic gas component absorbed therein;
a third unit configured to receive the second solution output stream, to separate the weak acidic gas component from the amine solution, to output a collection gas stream including the weak acid gas component separated from the amine solution, and to output a third solution output stream including the amine solution after separation of the weak acidic gas component; and
a fourth unit configured to receive the first solution output stream from the first unit and at least a portion of at least one of the second solution output stream from the second unit and the third solution output stream from the third unit, the fourth unit being configured to store amine solution in a storage tank, to measure a pH level of the amine solution in the storage tank, to add an alkaline compound to the amine solution based on the measured pH level, and to separate a solid reaction component formed by reaction of the alkaline compound and the strong acidic component from the amine solution, the amine solution from the fourth unit being supplied to the first and second units.

12. The apparatus of claim 11, wherein the second unit comprises an absorption tower and the third unit comprises a regeneration tower.

13. The apparatus of claim 11, wherein the first gas stream is from a cooling tower of an electrical power plant.

14. The apparatus of claim 11, wherein the fourth unit is configured to allow the alkaline compound to be added as a solid.

15. The apparatus of claim 14, wherein the storage tank includes a stirring unit.

16. The apparatus of claim 11, wherein the fourth unit includes a solid-liquid mixing tank configured to receive the alkaline compound as a solid, to dissolve the alkaline compound received as the solid, and output the alkaline compound to the storage tank as an aqueous solution.

17. The apparatus of claim 11, wherein the fourth unit includes a filter for separating the solid reaction component from the amine solution.

18. The apparatus of claim 11, wherein the alkaline compound comprises at least one of calcium hydroxide and barium hydroxide.

19. The apparatus of claim 11, wherein the weak acidic component comprises carbon dioxide.

20. The apparatus of claim 11, wherein the weak acidic component comprises carbon dioxide resulting from the combustion of a fossil fuel.
